(19) United States
(12) Patent Application Publication
(10) Pub. No.: US 2008/0120875 A1
(43) Pub. Date: May 29, 2008

(54) Automobile license plate frame

(76) Inventor: Pao-Hsin Yen, Kaohsiung County (TW)

Correspondence Address: Pao-Hsiu YEN, No. 24, Alley 53, Lane 2, Sec. 2,, Zhongshan Road, Hunei Shiang, Kaohsiung County, 829, omitted

(21) Appl. No.: 11/514,996

(22) Filed: Sep. 5, 2006

(51) Int. Cl. G09F 7/18; B60R 13/10

(52) U.S. Cl. 40/204

(57) ABSTRACT

An automobile license plate frame includes an auxiliary lamp unit assembled on the surface of the license plate frame. The auxiliary lamps assembled on the license plate frame are able to flash synchronously together with the directional lamp or the brake lamp of the automobile to enable the driver of the automobile coming from behind to clearly and quickly know the moving conditions of the automobile in front.

### BACKGROUND OF THE INVENTION

1. Field of the Invention

This invention relates to an automobile license plate frame, particularly to one provided thereon with auxiliary lamps able to flash synchronously together with the directional lamp or the brake lamp of the automobile so as to enable the driver of the automobile coming from behind to clearly and quickly know the moving paths and the moving conditions of the automobile running in front.

2. Description of the Prior Art

Generally, an automobile has its front and rear opposite sides respectively provided with a directional lamp, and some automobiles even have the rear sides of the rear-view mirrors respectively disposed with an auxiliary directional lamp. However, the auxiliary directional lamps installed at the rear sides of the rear-view mirrors can be seen only by the driver of the automobiles coming in opposite direction but cannot be seen by the driver of the automobile coming from behind. The driver of an automobile coming from behind can know the moving conditions of the automobile in front only by the rear conditional lamps, but actually the driver of the automobile coming behind always looks straight at the front and may neglect the opposite side lamps of the automobile in front. But an automobile generally is not provided with any auxiliary directional lamps at a rear side. Many automobiles have the periphery of the rear license plate 10 provided with a license plate frame 20 for enhancing integral beauty of the license plate 10, as shown in FIG. 1, but with no indicating lamps fixed on it. So it is an imagination of the invention to additionally install them on the license plate frame 20, and enable them to flash synchronously with the directional lamp or the brake lamp of an automobile to enable the driver of the automobile coming from behind to clearly know the moving conditions of the automobile in front.

### SUMMARY OF THE INVENTION

The obj ective of the invention is to offer an automobile license plate frame, including an auxiliary lamp unit assembled on the surface of the license plate frame. The auxiliary lamps of the auxiliary lamp unit are able to flash synchronously together with the moving path indicating lamp (like a directional lamp) or the moving condition indicating lamp (like a brake lamp) of the automobile to enable the driver of the automobile coming from behind to clearly know the moving paths and the moving conditions of the automobile in front.

### BRIEF DESCRIPTION OF DRAWINGS

This invention will be better understood by referring to the accompanying drawings, wherein:

FIG. 1 is a front view of a conventional automobile license plate frame;

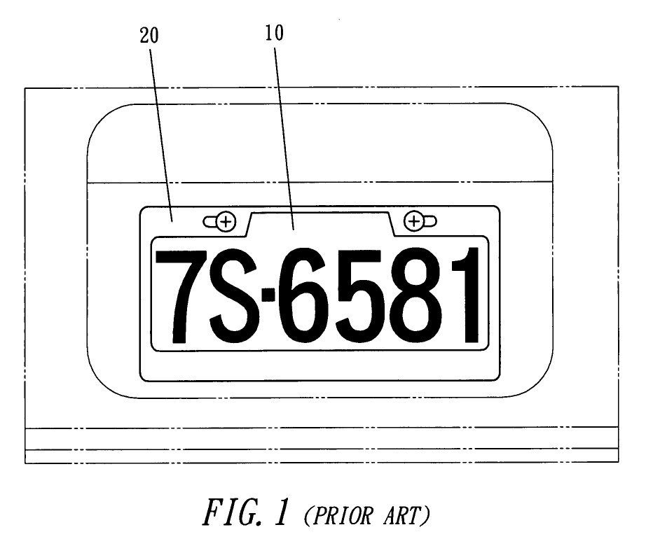

FIG. 2 is a front view of an automobile license plate frame in the present invention;

FIG. 3 is a perspective view of the automobile license plate frame assembled thereon with an auxiliary lamp unit in the present invention;

FIG. 4 is an exploded perspective view of the license plate frame and the auxiliary lamp unit in the present invention;

FIG. 5 is a cross-sectional view of the line 5-5 in FIG. 2; and

FIG. 6 is a cross-sectional view of the line 6-6 in FIG. 2.

### DETAILED DESCRIPTION OF THE PREFERRED EMBODIMENT

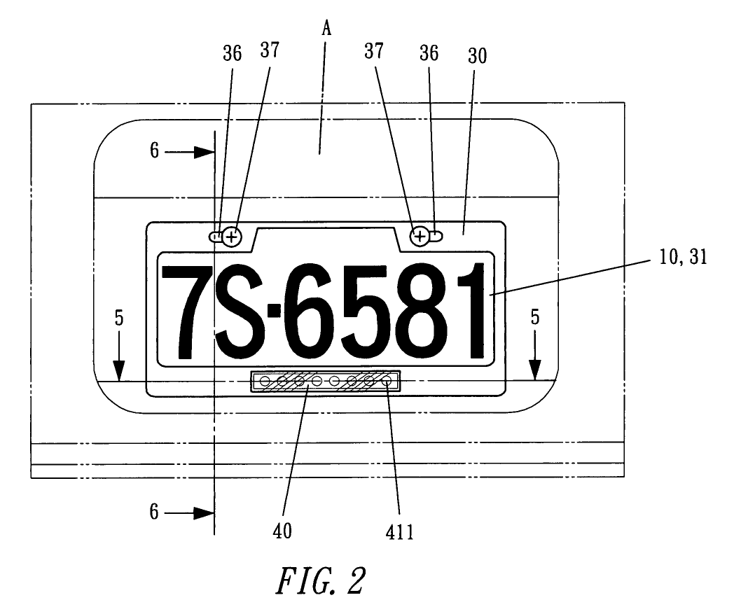

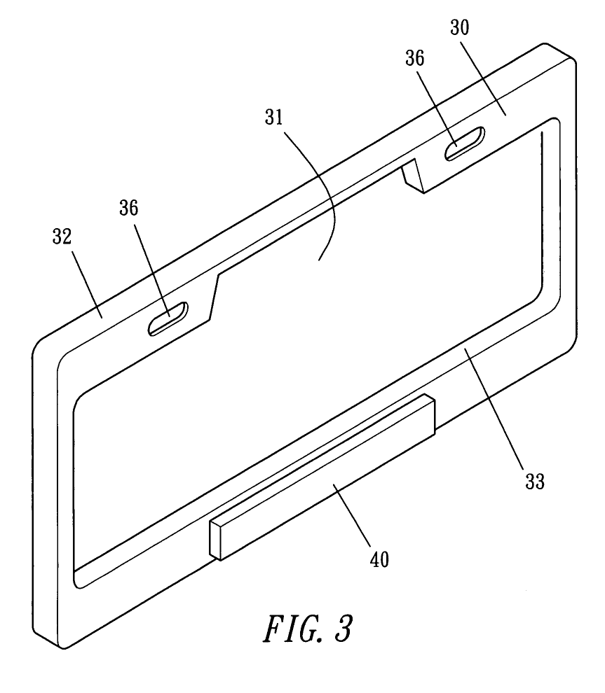

An automobile license plate frame in the present invention, as shown in FIGS. 2, 3 and 4, includes a license plate frame 30 and an auxiliary lamp unit 40 combined together.

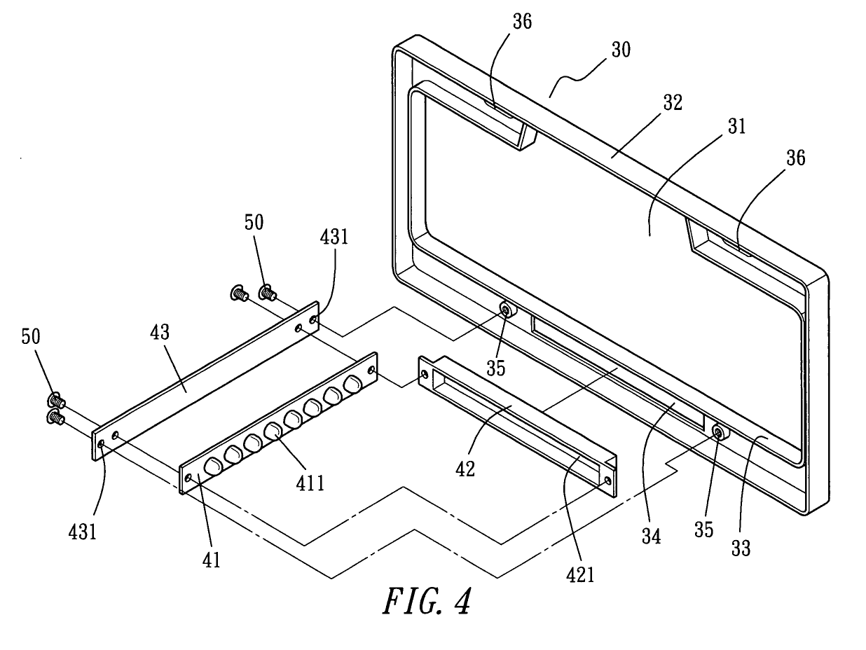

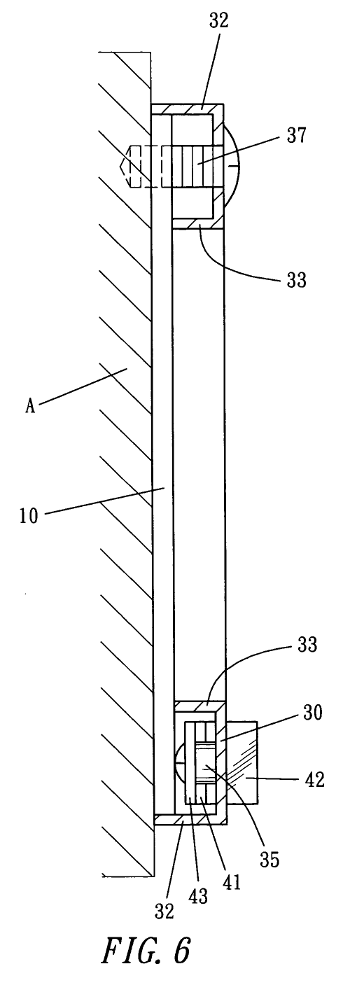

The license plate frame 30 has its central portion formed with a hollowed area 31 for fixing a license plate 10 thereon so that the number on the license plate 10 can be seen clearly through the hollowed area 31. The license plate frame 30 has its outer edge, and the hollowed area 31 has its inner wall respectively extending backward and forming an outer lip 32 and an inner lip 33. The outer lip 32 of the license plate frame 30 has its inner edge engaged with the outer edge of the license plate 10. The outer lip 32 of the license plate frame 30 is a little wider than the inner lip 33 of the hollowed area 31, and the width difference between the outer lip 32 and the inner lip 33 is equivalent to the thickness of the license plate 10, letting the inner lip 33 of the hollowed area 31 rest on the surface of the license plate 10, as shown in FIG. 6. Further, the license plate frame 30 has its lower central portion formed with a lengthwise accommodating space 34 with its opposite sides respectively bored with a threaded hole 35 at the rear side of the license plate frame 30, as shown in FIG. 4. Furthermore, the license plate frame 30 has its upper opposite sides near the hollowed area 31 respectively bored with an insert hole 36 aligned to the fixing hole of the license plate 10 so that the license plate frame 30 and the license plate 10 together can be secured on the faceplate (A) of an automobile.

The auxiliary lamp unit 40 received in the accommodating space 34 of the license plate frame 30 is composed of a PC plate 41 for installing LED auxiliary lamps 411 thereon, a transparent cover 42 and a fixing plate 43. The PC plate 41 and the transparent cover 42 are of a same length, while the fixing plate 43 is a little longer than the PC plate 41 and the transparent cover 42. A plurality of auxiliary lamps 411 is regularly arranged on the PC plate 41, able to flash synchronously together with the directional lamp or the brake lamp of the automobile. The transparent cover 42 is formed with a lengthwise recessed groove 421 for receiving the auxiliary lamps 411 on the PC plate 41, and the fixing plate 43 has its opposite ends respectively bored with insert holes 431 matching with the threaded holes 35 of the license plate frame 30.

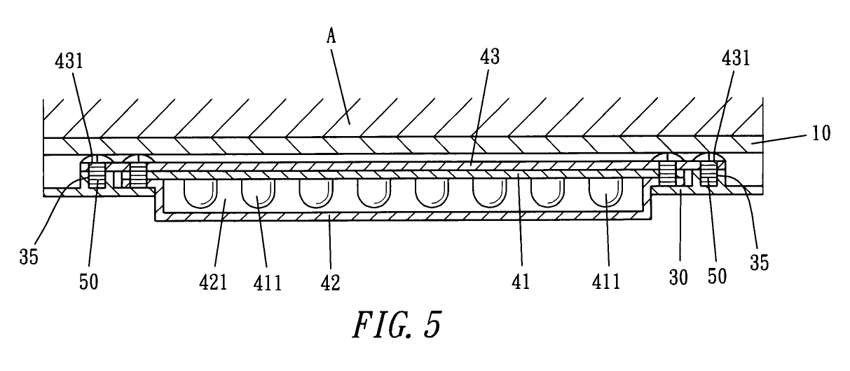

In assembling, firstly, assemble the auxiliary lamp unit 40 and then install the whole auxiliary lamp unit 40 in the accommodating space 34 of the license plate frame 30, letting the transparent cover 42 exposed to the outside. Next, insert bolts 50 respectively through the insert holes 431 of the fixing plate 43 of the auxiliary lamp unit 40 and screw them with the threaded holes 35 of the license plate frame 30 to combine the auxiliary lamp unit 40 together with the license plate frame 30, as shown in FIG. 5. Lastly, position the license plate 10 between the outer lip 32 of the license plate frame 30 and the inner lip 33 of the hollowed area 31 of the license plate frame 30 and then insert combining members 37 respectively through the insert holes 36 at the upper side of the license plate frame 30 and the fixing holes of the license plate 10 to fix the license plate frame 30 and the license plate 10 on the faceplate (A) of the automobile, as shown in FIG. 6.

By so designing, the auxiliary lamps 411 of the auxiliary lamp unit 40 can flash synchronously together with the left and the right directional lamp. When the automobile is to turn left and the left directional light on the license plate frame 30 flashes, the auxiliary lamps 411 of the auxiliary lamp unit 40 will synchronously flash from the right to the left. On the contrary, when the automobile is to turn right and the right directional light flashes, the auxiliary lamps 411 of the auxiliary lamp unit 40 will synchronously flash from the left to the right. Generally, the license plate 10 of an automobile is positioned right in the rear center of the automobile; therefore, when the automobile in front is to turn left or turn right and the auxiliary lamps 411 on the license plate frame 30 flashes, the driver of the automobile coming from behind can clearly and quickly know the moving conditions of the automobile in front.

In addition, the auxiliary lamp unit 40 of this invention can function synchronously with the brake lamp of the automobile, that is, when the automobile is braked, the auxiliary lamps 411 of the auxiliary lamp unit 40 and the brake lamp will flash together synchronously. Moreover, the auxiliary lamp unit 40 of this invention can also function together with the directional lamp and the brake lamp at the same time, that is, whenever the automobile is turned left or right, or is braked, the auxiliary lamps 411 of the auxiliary lamp unit 40 will flash together with the directional lamps or with the brake lamp synchronously.

To sum up, the auxiliary lamps provided on the license plate frame of this invention enable the driver of the automobile coming from behind to clearly know the moving path and the moving condition of the automobile in front, having originality and practicability.

While the preferred embodiment of the invention has been described above, it will be recognized and understood that various modifications may be made therein and the appended claims are intended to cover all such modifications that may fall within the spirit and scope of the invention.

1. An automobile license plate frame comprising an auxiliary lamp unit, said auxiliary lamp unit assembled on a surface of said license plate frame, a plurality of auxiliary lamps on said license plate frame able to flash synchronously together with a moving path indicating lamp or a moving condition indicating lamp of the automobile.

2. The automobile license plate frame as claimed in claim 1, wherein said moving path indicating lamp is a directional lamp of the automobile.

3. The automobile license plate frame as claimed in claim 1, wherein said moving condition indicating lamp is a brake lamp of the automobile.

4. The automobile license plate frame as claimed in claim 1,. wherein said auxiliary lamps are able to flash synchronously together with said moving path indicating lamp and said moving condition indicating lamp.

5. The automobile license plate frame as claimed in claim 1, wherein said auxiliary lamps are fixed in an accommodating space bored in a lower center of said license plate frame.
